(19) United States
(12) Patent Application Publication
(10) Pub. No.: US 2016/0314526 A1
(43) Pub. Date: Oct. 27, 2016

(54) NOTIFYING DEVICE, NOTIFYING METHOD, PROGRAM AND NON-TRANSITORY RECORDING MEDIUM

(71) Applicant: RAKUTEN, INC, Tokyo (JP)

(72) Inventors: Hyoseok GONG, Tokyo (JP); Yoovraj SHINDE, Tokyo (JP)

(73) Assignee: Rakuten, Inc., Tokyo (JP)

(21) Appl. No.: 15/103,445

(22) PCT Filed: May 30, 2014
(86) PCT No.: PCT/JP2014/064379

§ 371 Date: Jun. 10, 2016

(51) Int. Cl. G06Q 30/08

(52) U.S. Cl. CPC G06Q 30/08; H04M 15/8358

(57) ABSTRACT

A notification-date-and-hour obtaining unit obtains a notification date and hour for transactions watched by a user, and preceded by a set time interval from a deadline for each transaction. Notification of transaction deadlines are sent after the notification date and hour associated with each transaction comes. When the user takes an action designated in the notification by the deadline, a presenting unit determines a collective time period containing the deadline for the transaction subjected to the notification. Next, the presenting unit presents to the user, a request page of the transaction subjected to the notification when the transaction within the collective time period and reaching the deadline within the collective time period is only the transaction subjected to the notification. The presenting unit collects information of respective request pages for the transactions within the collective time period when there are multiple transactions within the collective time period.

### TECHNICAL FIELD

The present disclosure relates to a notifying device, a notifying method, a program, and a non-transitory recording medium.

### BACKGROUND ART

In the field of electronic transactions, conventionally, there are services that remind a user of, so as not to let the user to forget to make a request for purchasing a product, the request deadline prior to the request deadline for purchasing the product. For example, Patent Literature 1 discloses a system that transmits, to a user, when the user registers an interesting product on a WEB site for electronic transactions, an electronic mail (a reminder mail) that notifies the user of, when the request deadline for purchasing the registered product in the watch list approaches, the approaching request deadline.

### CITATION LIST

### Patent Literature

Patent Literature 1: Japanese Patent No. 5145578

### SUMMARY OF INVENTION

### Technical Problem

According to the system disclosed in Patent Literature 1, when multiple products with the near purchase request deadlines are registered in the watch list, multiple reminder mails are individually transmitted to the user at near clock times. Hence, the user may miss an opportunity to check some of the multiple reminder mails. Consequently, the user may forget about the purchase request deadline for the product relating to missed reminder mail, and miss the opportunity to make a request.

The present disclosure has been made in view of the aforementioned circumstances, and it is an objective of the present disclosure to provide a notifying device, a notifying method, a program, and a non-transitory recording medium which can prevent a user from forgetting to make a request for a transaction when the user watches multiple transactions with near transaction deadlines.

### Solution to Problem

In order to accomplish the above objective, a notifying device according to a first aspect includes:

an obtaining unit that obtains a notification date and hour which is associated with each of a plurality of transactions watched by a user, and which precedes by a set time interval from a deadline for the each transaction;

a notification sending unit that sends a notification of the deadline for the each transaction to the user after the notification date and hour associated with the each transaction comes; and

a presenting unit which determines, when the notified user takes an action designated in the notification by the deadline for the transaction subjected to the notification, a collective time period that contains the deadline for the transaction subjected to the notification among the plurality of transactions presents, to the user a request page of the transaction subjected to the notification when the transaction reaching the deadline within the collective time period is only the transaction subjected to the notification, and collects up and presents, to the user, pieces of information of respective request pages for the transactions reaching the deadline within the collective time period when there are plurality of the transactions reaching the deadline within the collective time period.

In the notifying device of the above aspect, the presenting unit presents, to the user, a listing page that lists up links to the respective request pages for the transactions reaching the deadline within the collective period, thereby collectively presenting, to the user, the pieces of information for the respective request pages for the transactions within the collective time period.

In the notifying device of the above aspect:

a start of the collective time period is a time point preceding by a first time length from the deadline for the transaction;

an end of the collective time period is a later time point than the deadline for the transaction by a second time length; and

the notifying device further comprises:
a calculating unit that calculates a reaction level to the sent notification based on the action taken by the user to the each transaction reaching the deadline within the collective time period; and
an updating unit that updates the first time length, the second time length, and the time interval so as to improve the calculated reaction level.

In the notifying device of the above aspect, when the reaction level improves by tentatively changing the first time length, the second time length, and the time interval, the updating unit may update the first time length, the second time length, and the time interval with the respective tentatively changed values.

In the notifying device of the above aspect:

the action may be to access the request page for the each transaction within the collective time period by the user from the listing page after the notification is sent; and

the reaction level may be calculated so as to have a negative correlation with an average of times from a time point at which the notification is sent to a time point at which the access to the request page for the each transaction within the collective time period is made.

In the notifying device of the above aspect:

the action may be to access the request page for the each transaction within the collective time period by the user from the listing page after the notification is sent or to make a request from the request page accessed from the listing page; and

the reaction level may be calculated so as to have a positive correlation with a number of accesses or a number of requests.

In the notifying device of the above aspect, the presenting unit presents, through different browser windows from each other or different tabs from each other in a browser, all request pages of the respective transactions within the collective time period, thereby collectively presenting, to the user, the pieces of information for the respective request pages for the transactions reaching the deadline within the collective time period.

In the notifying device of the above aspect, the notifying device may:

determine, every time the user sets a new transaction as a watching target, whether or not a condition is satisfied, the condition being that “there is an existing transaction watched by the user, the deadline of the existing transaction is faster than the deadline of the new transaction, and the notification date and hour of the new transaction is contained within the collective time period set for the existing transaction”;

register, in the mail server, prescheduling of transmitting a mail described with the notification of the deadline for the new transaction at the notification date and hour of the new transaction when the condition is unsatisfied; and

notify the user of an omission of the notification of the deadline for the new transaction when the condition is satisfied.

A notifying method according to a second aspect of the present disclosure is executed by a notifying device that includes an obtaining unit, a notification sending unit, and a presenting unit, and the method includes:

obtaining by the obtaining unit a notification date and hour which is associated with each of a plurality of transactions watched by a user, and which precedes by a set time interval from a deadline for the each transaction;

sending a notification by the notification sending unit of the deadline for the each transaction to the user after the notification date and hour associated with the each transaction comes; and

determining by the presenting unit, when the notified user takes an action designated in the notification by the deadline for the transaction subjected to the notification, a collective time period that contains the deadline for the transaction subjected to the notification among the plurality of transactions presenting to the user a request page of the transaction subjected to the notification when the transaction reaching the deadline within the collective time period is only the transaction subjected to the notification, and collecting up and presenting the user pieces of information of respective request pages for the transactions within the collective time period when there are plurality of transactions reaching the deadline within the collective time period.

A program according to a third aspect of the present disclosure causes a computer to function as:

an obtaining unit that obtains a notification date and hour which is associated with each of a plurality of transactions watched by a user, and which precedes by a set time interval from a deadline for the each transaction;

a notification sending unit that sends a notification of the deadline for the each transaction to the user after the notification date and hour associated with the each transaction comes; and

a presenting unit which determines, when the notified user takes an action designated in the notification by the deadline for the transaction subjected to the notification, a collective time period that contains the deadline for the transaction subjected to the notification among the plurality of transactions, presents to the user a request page of the transaction subjected to the notification when the transaction reaching the deadline within the collective time period is only the transaction subjected to the notification, and collects up and present to the user pieces of information of respective request pages for the transactions reaching the deadline within the collective time period when there are plurality of transactions reaching the deadline within the collective time period.

A non-transitory computer-readable recording medium according to a fourth aspect of the present disclosure has stored therein a program that causes a computer to function as:

an obtaining unit that obtains a notification date and hour which is associated with each of a plurality of transactions watched by a user, and which precedes by a set time interval from a deadline for the each transaction;

a notification sending unit that sends a notification of the deadline for the each transaction to the user after the notification date and hour associated with the each transaction comes; and

a presenting unit which determines, when the notified user takes an action designated in the notification by the deadline for the transaction subjected to the notification, a collective time period that contains the deadline for the transaction subjected to the notification among the plurality of transactions, presents to the user a request page of the transaction subjected to the notification when the transaction reaching the deadline within the collective time period is only the transaction subjected to the notification, and collects up and present to the user pieces of information of respective request pages for the transactions reaching the deadline within the collective time period when there are plurality of transactions reaching the deadline within the collective time period.

### Advantageous Effects of Invention

According to the present disclosure, the user can be prevented from forgetting to make a request for a transaction when the user watches multiple transactions with near transaction deadlines.

### BRIEF DESCRIPTION OF DRAWINGS

FIG. 1 is a schematic block diagram illustrating an example structure of a notifying system according to a first embodiment;

FIG. 2 is a schematic block diagram illustrating an example hardware structure of the notifying device of the first embodiment;

FIG. 3 is a schematic block diagram illustrating an example functional structure of the notifying device of the first embodiment;

FIG. 4 is a diagram illustrating example data stored in a product table;

FIG. 5 is a diagram illustrating example data stored in a bidding table;

FIG. 6 is a diagram illustrating an example search result page;

FIG. 7 is a diagram illustrating an example request page;

FIG. 8 is a diagram illustrating an example notification message;

FIG. 9 is a diagram for explaining an example determining method of a collective time period;

FIG. 10 is a diagram illustrating an example deadline listing page;

FIG. 11 is an example flowchart of a registering process;

FIG. 12 is an example flowchart of a notifying process;

FIG. 13 is an example flowchart of a presenting process;

FIG. 14 is a schematic block diagram illustrating an example functional structure of a notifying device according to a second embodiment;

FIG. 15 is a diagram illustrating example data stored in a parameter table;

FIG. 16 is a diagram illustrating example data stored in a log table;

FIG. 17 is an example flowchart of a parameter updating process;

FIG. 18 is a schematic block diagram illustrating an example structure of a notifying device according to a fifth embodiment;

FIG. 19 is a diagram illustrating example data stored in a notification mail prescheduling table; and

FIG. 20 is an example flowchart of a notification registering process.

### DESCRIPTION OF EMBODIMENTS

Embodiments of the present disclosure will be explained in detail with reference to the figures.

### First Embodiment

A notifying system 1 according to a first embodiment of the present disclosure notifies a user of an approaching deadline prior to a transaction request deadline. In the first embodiment, an explanation will be given of an example case in which the transaction request deadline is the date and hour at which a bidding in an Internet auction is closed (hereinafter, referred to as a bidding deadline).

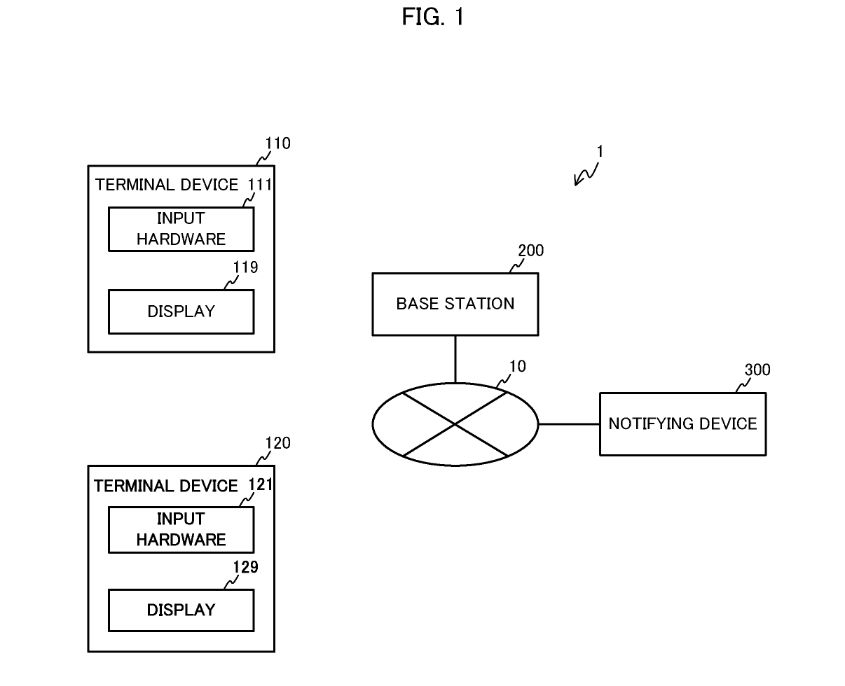

As illustrated in FIG. 1, the notifying system 1 includes terminal devices 110, 120, a base station 200 wirelessly communicable with the terminal devices 110, 120, and a notifying device 300 communicably connected with the base station 200 via a computer communication network 10 (hereinafter, simply referred to as a communication network 10).

The communication network 10 is, for example, the Internet. The communication network 10 may be a Local Area Network (LAN) or a public line network.

The terminal devices 110 and 120 are each, for example, a mobile telephone. The terminal devices 110 and 120 may be each a laptop personal computer or a tablet computer.

The terminal device 110 is a device which searches products that allow the user to place a bid on the Internet auction, and which is utilized to place a bid. The terminal device includes an input hardware 111 like a touch pad, and, a display 119 like an Liquid Crystal Display (LCD). The terminal device 120 includes an input hardware 121 and a display 129 that have the same structure as those of the input hardware 111 and display 119 of the terminal device 110, respectively. Since the terminal devices 110 and 120 have the same structure and the same operation, the following explanation will be mainly given of the terminal device 110.

The base station 200 is, for example, a base station for mobile telephones, or a wireless LAN base station. The base station 200 relays a communication between the terminal devices 110, 120 and the notifying device 300.

The notifying device 300 includes, for example, a server device, and executes, in accordance with a request from the terminal device 110, a searching process and a bidding process for products that allow the user to place a bid on the Internet auction.

In addition, the notifying device 300 accepts a registration of a product (hereinafter, referred to as a watching product) that the user wants to watch a transaction, and registers the watching product in a watch list from the terminal device 110. In this case, the terms watching a transaction mean receiving a notification of a change in the transaction status. This notification is given to the user who has identification information (hereinafter, referred to as a user ID) registered in a list called the watch list and stored in the notifying device 300. Hence, the user who watches a transaction will be also referred to as a user registered in the watch list. The notification of a change in the transaction status includes a notification of the approaching transaction request deadline, but the present disclosure is not limited to this form. For example, in the case of a bidding transaction, notifications of a change in the highest bid price and a change of a user bidding at the maximum price (hereinafter, referred to as the highest bidder) to another user may be performed.

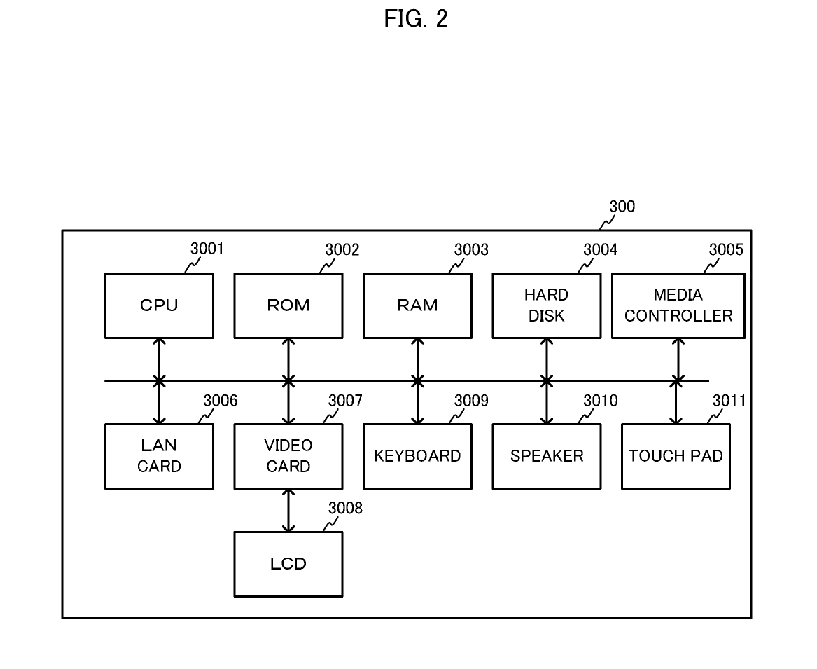

FIG. 2 illustrates an example hardware structure of the notifying device 300. As illustrated in FIG. 2, the notifying device 300 includes a Central Processing Unit (CPU) 3001, a Read Only Memory (ROM) 3002, a Random Access Memory (RAM) 3003, a hard disk 3004, a media controller 3005, a Local Area Network (LAN) card 3006, a video card 3007, an Liquid Crystal Display (LCD) 3008, a keyboard 3009, a speaker 3010, and a touch pad 3011.

The CPU 3001 that executes a program in accordance with a program stored in the ROM 3002 or in the hard disk 3004 controls the whole notifying device 300. The RAM 3003 is a work memory that temporarily stores data to be processed when the CPU 3001 executes a program.

The hard disk 3004 is an information storage that stores tables each containing various data. The notifying device 300 may include a flash memory instead of the hard disk 3004.

The media controller 3005 reads, from non-transitory recording media, such as a flash memory, a CD (Compact Disc), a DVD (Digital Versatile Disc), and Blu-ray Disc (Blu-ray Disc) (Registered Trademark), various data and programs.

The LAN card 3006 exchanges data between the terminal devices 110 and 120 connected via the communication network 10 through the base station 200. The keyboard 3009 and the touch pad 3011 input signals in accordance with an operation given by the user.

The video card 3007 depicts (that is, renders) images based on digital signals output by the CPU 3001, and outputs image signals representing depicted images. The LCD 3008 displays images in accordance with image signals output by the video card 3007. The notifying device 300 may include a PDP (Plasma Display Panel) or EL (Electroluminescence) display instead of the LCD 3008. The speaker 3010 outputs sounds based on signals output by the CPU 3001.

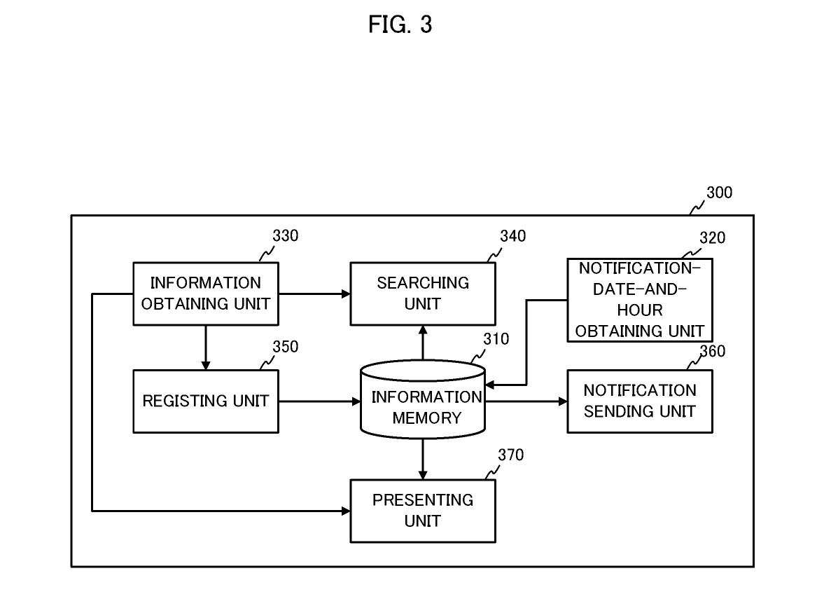

Next, an explanation will be given of functions of the notifying device 300. As illustrated in FIG. 3, the notifying device 300 functions as an information memory 310, a notification-date-and-hour obtaining unit 320, an information obtaining unit 330, a searching unit 340, a registering unit 350, a notification sending unit 360, and a presenting unit 370.

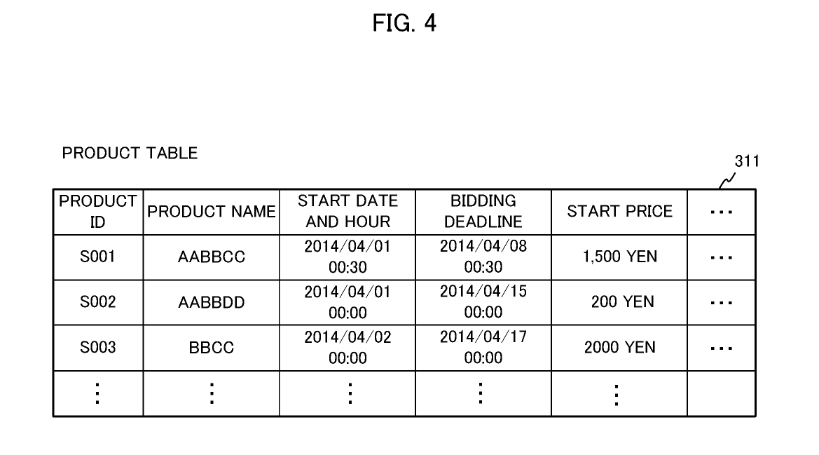

The information memory 310 stores a product table 311 as illustrated in FIG. 4. The product table 311 contains multiple records associated with information (hereinafter, referred to as a product ID) identifying a product put up in the auction, a product name, the date and hour at which the auction for the product starts, the date and hour at which the auction for the product ends (hereinafter, referred to as a bidding deadline), and the price of the product at the time of the start of the auction. Those records are recorded in the product table 311 by a seller of the product or the manager of the notifying device 300.

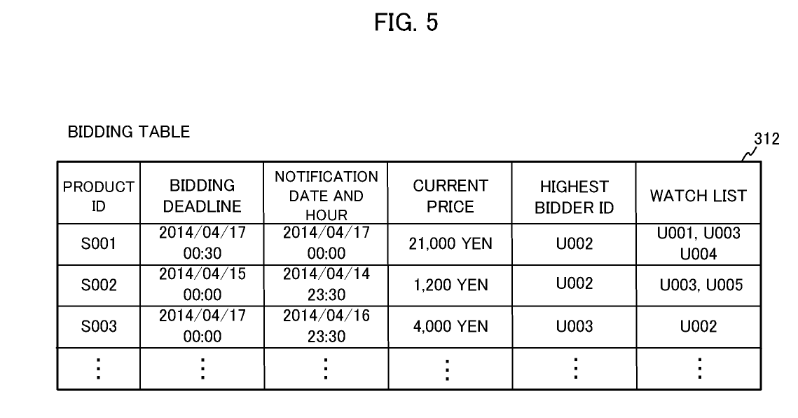

In addition, the information memory 310 also stores a bidding table 312 illustrated in FIG. 5. The bidding table contains multiple records associated with the product ID stored in the product table 311 in FIG. 4, the bidding deadline for the product identified by the product ID, the date and hour (hereinafter, referred to as a notification date and hour) notifying the user of the approaching bidding deadline, the current price of the product, the user ID of the highest bidder, and the user ID of the user who has registered the product in the watch list.

The hard disk 3004 illustrated in FIG. 2 works together with the CPU 3001 to function as the information memory 310 illustrated in FIG. 3.

The notification-date-and-hour obtaining unit 320 obtains, for each product recorded in the bidding table 312, the date and hour advanced from the bidding deadline for the product by a notification interval set beforehand as a notification date and hour. Next, the notification-date-and-hour obtaining unit 320 stores the obtained notification date and hour in the bidding table 312. In the first embodiment, the notification interval is set as 30 minutes, but the present disclosure is not limited to this time interval.

The CPU 3001 illustrated in FIG. 2 functions as the notification-date-and-hour obtaining unit 320 illustrated in FIG. 3.

The information obtaining unit 330 obtains various pieces of information from the terminal device 110. For example, the information obtaining unit 330 obtains, from the terminal device 110, a search request that requests the searching of the products that allow the user to place a bid on the Internet auction. The search request contains data representing a product search condition input by the user through the input hardware 111 of the terminal device 110. The information obtaining unit 330 outputs, upon obtainment of the search request, data contained in the search request to the searching unit 340.

In addition, the information obtaining unit 330 obtains a watch request that requests a registration of the product that allows the user to place a bid on the Internet auction in the watch list. The watch list contains the user ID of the user of the terminal device 110, and information (hereinafter, referred to as a watching product ID) that identifies the product to be watched. When obtaining the watch request, the information obtaining unit 330 outputs, to the registering unit 350, data contained in the watch request.

Still further, the information obtaining unit 330 obtains, from the terminal device 110, a transmission request that requests a transmission of a request page for a biding requesting to the product that allows the user to place a bid on the Internet auction. The transmission request contains the user ID of the user of the terminal device 110, and information (hereinafter, referred to as a bidding product ID) that identifies the product to be bidden. When obtaining the transmission request, the information obtaining unit 330 outputs data contained in the transmission request to the presenting unit 370.

Yet still further, the information obtaining unit 330 obtains a bidding request that requests a bidding on the product that allows the user to place a bid on the Internet auction. The bidding request contains the user ID (hereinafter, referred to as a bidding user ID) of the user of the terminal device 110, the bidding product ID, and the bid price of the bidding product. The information obtaining unit 330 outputs, when obtaining the bidding request, data contained in the bidding request to the registering unit 350.

The LAN card 3006 illustrated in FIG. 2 works together with the CPU 3001 to function as the information obtaining unit 330 illustrated in FIG. 3.

The searching unit 340 searches, based on data indicating a product search condition and contained in the search request obtained by the information obtaining unit 330, the products that match the search condition from the product table 311. Next, the searching unit 340 transmits, to the terminal device 110 that has transmitted the search request, information on the products that match the search condition.

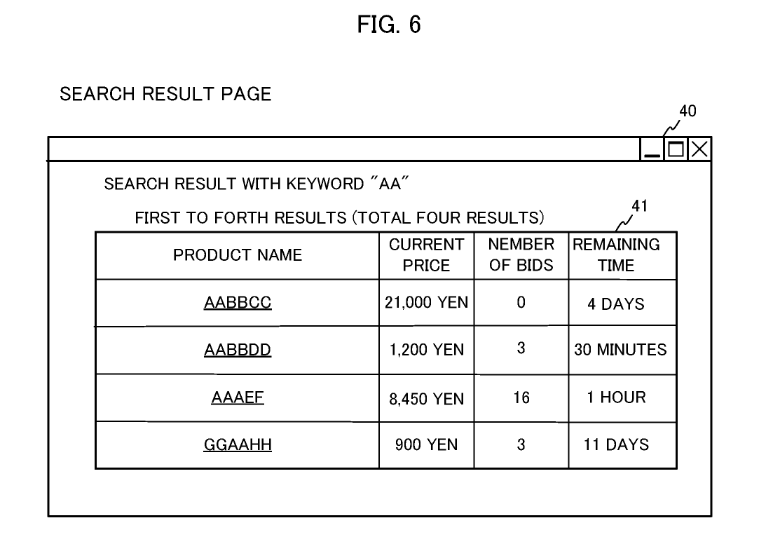

For example, the searching unit 340 obtains, from the product table 311, pieces of information on the name of product, the current price, the number of bids, and the bidding deadline which meet the search condition. Next, as illustrated in, as an example, FIG. 6, the searching unit 340 transmits, to the terminal 110, a search result page 40 that contains a search result list 41 that lists up the pieces of obtained information.

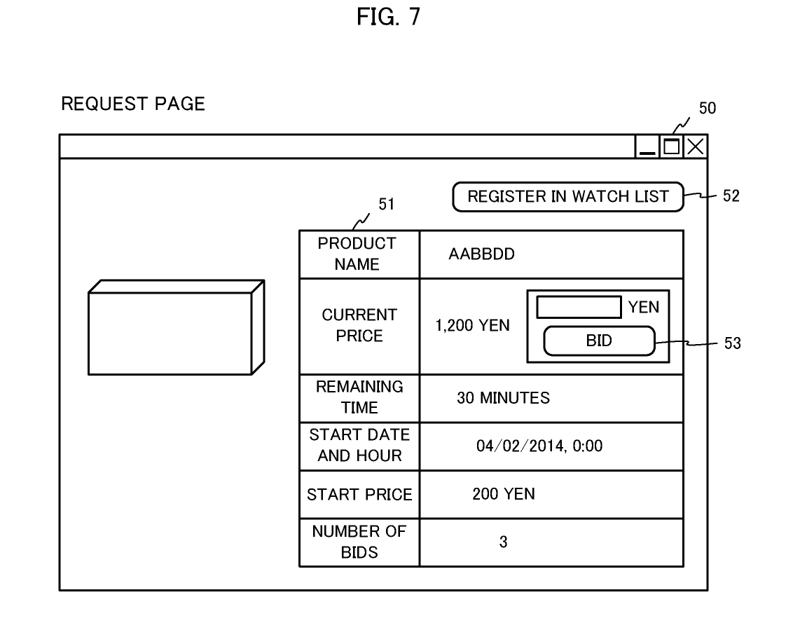

When the user of the terminal device 110 views the search result page 40 displayed on the display 119, and selects an interesting product from the search result list 41, as illustrated in, as an example, FIG. 7, the searching unit 340 transmits, to the terminal device 110, a request page 50 for requesting a bidding on the selected product. The request page 50 contains product information 51 representing information on the product and the bidding, a register button 52 to register the user of the terminal device 110 in the watch list for this product, and a bid button 53 to place a bid on this product. When the user selects the register button 52, the terminal device 110 transmits the watch request for the product to the notifying device 300. In addition, when the user selects the bid button 53, the terminal device 110 transmits the bidding request for the product to the notifying device 300.

The CPU 3001 illustrated in FIG. 2 works together with the LAN card 3006 to function as the searching unit 340 illustrated in FIG. 3.

The registering unit 350 adds, to the watch list of the bidding table 312, the user based on the watching product ID and the user ID contained in the watch list obtained by the information obtaining unit 330. More specifically, in the bidding table 312, the registering unit 350 adds, to the watch list for the product ID corresponding to the watching product ID in the watch request, the user ID contained in that watch request.

In addition, the registering unit 350 updates, based on the bidding product ID, the bidding user ID, and the bid price contained in the bidding request obtained by the information obtaining unit 330, the current price and the highest bidder ID in the watch list of the bidding table 312. More specifically, the registering unit 350 updates, in the bidding table 312, the current price of the product ID corresponding to the bidding product ID with the bid price contained in the bidding request, and also updates the highest bidder ID with the bidding user ID contained in the bidding request.

The CPU 3001 illustrated in FIG. 2 functions as the registering unit 350 illustrated in FIG. 3.

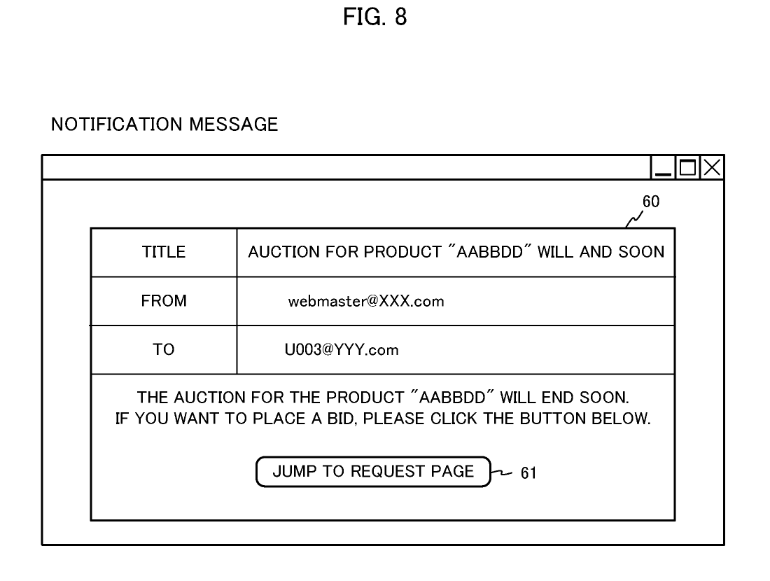

When the current date and hour reaches the notification date and hour recorded in the bidding table 312, the notification sending unit 360 sends, to the user with the user ID registered in the watch list for the product that has reached the notification date and hour, a notification message 60 to the effect that the bidding deadline for the product is soon. FIG. 8 illustrates an example notification message 60 displayed on the display 119 of the terminal device 110. The notification message illustrated in FIG. 8 contains the name of product that has reached the notification date and hour, a message that designates an action to display the request page for this product, and a page jump button 61. More specifically, in the notification message 60, as an action to display the request page 50 for the product, clicking of the page jump button 61 is designated. When the user of the terminal device 110 clicks the page jump button 61 through the input hardware 111, the terminal device 110 transmits the transmission request to the notifying device 300.

The CPU 3001 illustrated in FIG. 2 works together with the LAN card 3006 to function as the notification sending unit 360 illustrated in FIG. 3.

The presenting unit 370 presents, based on the bidding product ID and the user ID both contained in the transmission request obtained by the information obtaining unit 330, the request page or a deadline listing page collecting up pieces of information on the request pages to the terminal device 110.

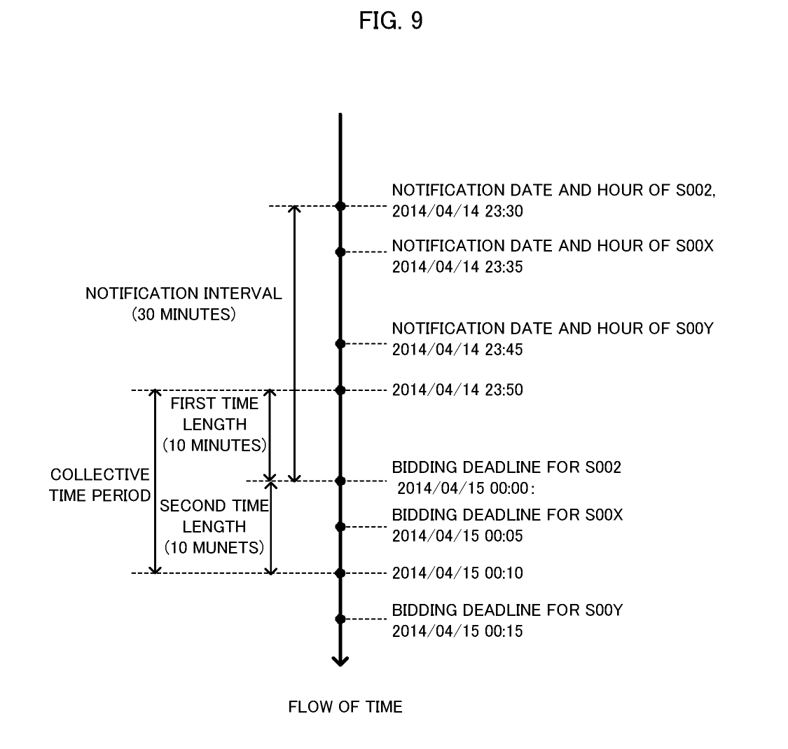

When, for example, in the bidding table 312, the bidding deadline for the product ID corresponding to the bidding product ID contained in the transmission request is the later time than the current date and hour, the presenting unit 370 determines the collective time period. In this case, an explanation will be given of the collective time period with reference to FIG. 9. An explanation will be given of an example case in which, in FIG. 9, a user ID “U003” is registered in the watch lists of the product IDs “S002”, “S00X”, and “S00Y” in the bidding table 312. As illustrated in FIG. 9, when, for example, the bidding deadlines for the product IDs “S002”, “S00X”, and “S00Y” are “2014/04/15, 00:00”, “2014/04/15, 00:05” and “2014/04/15, 00:15”, respectively, the notification date and hour corresponding to each product ID is advanced by the notification interval of 30 minutes from the bidding deadline, that is, “2014/04/14, 23:30”, “2014/04/14, 23:35”, and “2014/04/14, 23:45”. In this case, it is assumed that the current date and hour reaches “2014/04/14, 23:30”, the notification message to the effect that the bidding deadline for the product ID “S002” is soon is transmitted to the user with the user ID of “U003”, and the user with the user ID of “U003” clicks the page jump button 61 contained in this notification message at “2014/04/14, 23:35”. In this case, the presenting unit 370 determines, as the collective time period, a time period from a time point advanced from the bidding deadline of the bidding product ID by a first time length to a later time point than the bidding deadline by a second time length. More specifically, the presenting unit 370 determines, as the collective time period, a time period from the time point “2014/04/14, 23:50” advanced from the bidding deadline “2014/04/15, 00:00” of the product ID “S002” by the first time length that is 10 minutes to a later time point “2014/04/15, 00:10” than the bidding deadline “2014/04/15, 00:00” of the product ID “S002” by the second time length that is 10 minutes. Although the explanation was given that both first time length and second time length are 10 minutes, the present disclosure is not limited to this setting.

Next, the presenting unit 370 presents, to the terminal device 110, the request page 50 for the product as illustrated in FIG. 7 when the product that reaches the bidding deadline within the collective time period among the products with the user ID contained in the transmission request and registered in the watch list of the bidding table 312 is only the product relevant to the bidding product ID.

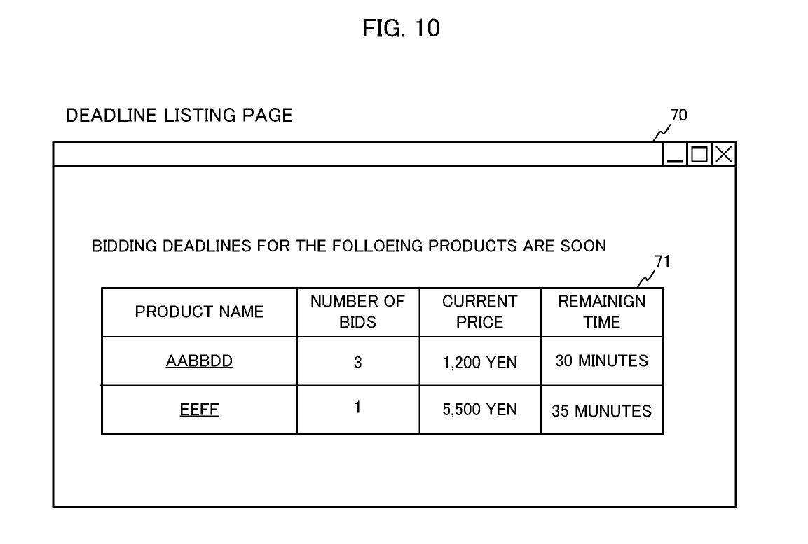

In addition, when there is the other product reaching the bidding deadline within the collective time period than the product relevant to the bidding product ID, the presenting unit 370 presents, to the terminal device 110, a deadline listing page 70 illustrated in FIG. 10. The deadline listing page 70 illustrated in FIG. 10 contains, for each product reaching the bidding deadline within the collective time period, a deadline list 71 containing pieces of information on the product name, the number of bids, the current price, and the remaining time. In addition, each product name contained in the deadline list 71 corresponds to the link of the bidding request page 50 for the product. Hence, when the user of the terminal device 110 selects the product name contained in the deadline list 71, the bidding request page 50 for the product is presented on the display 119 of the terminal device 110.

In the case of, for example, FIG. 9, the bidding deadlines for the product IDs “S002” and “S00X” come within the determined collective time period that is from “2014/04/15, 00:00” to “2014/04/15, 00:10”. Hence, the presenting unit 370 determines that there is the other product reaching the bidding deadline within the collective time period than the product relevant to the bidding product ID “S002”, and presents, to the terminal device 110, the deadline listing page 70 illustrated in FIG. 10.

After the request page 50 is presented to the terminal device 110, when the user inputs the bid price and selects the bid button 53 in the request page 50 through the input hardware 111, the terminal device 110 transmits, to the notifying device 300, the bidding request that contains the bid price and the user ID of the user, thereby requesting a bidding.

Next, an explanation will be given of an operation of the notifying system 1 of this embodiment.

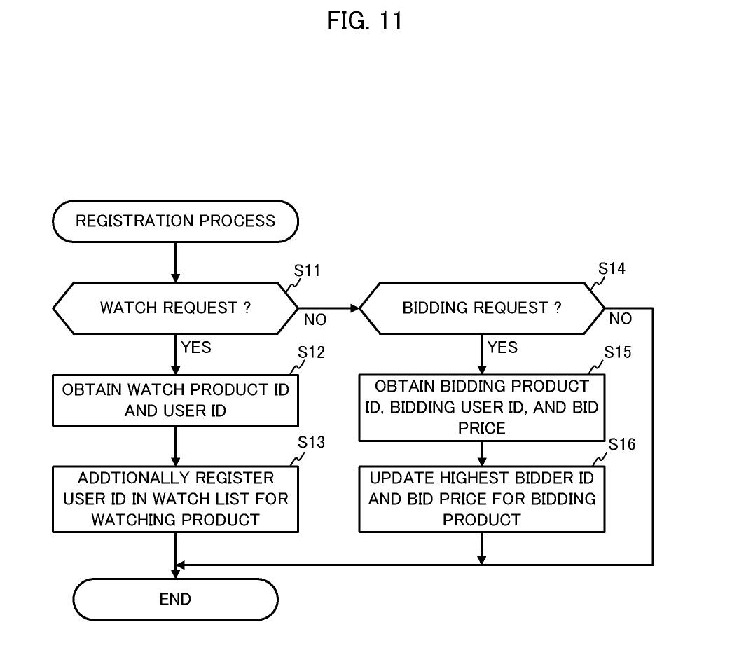

First, a registering process executed by the notifying device 300 will be explained. FIG. 11 is an example flowchart of the registering process. The registering process illustrated in FIG. 11 starts upon, for example, reception of a request from the terminal device 110.

First, the information obtaining unit 330 determines whether or not the request received from the terminal device 110 is the watch request (step S11).

When determining that the request received from the terminal device 110 is the watch request (step S11: YES), the information obtaining unit 330 obtains the user ID and the watching product ID both contained in the watch request (step S12).

Next, the registering unit 350 additionally registers the obtained user ID in the watch list (that is, the watch list for the watching product) of the product ID corresponding to the watching product ID stored in the bidding table 312 in FIG. 5 (step S13). Subsequently, the registering unit 350 terminates the execution of the registering process.

In addition, when determining that the request received from the terminal device 110 is not the watch request (step S11: NO), the information obtaining unit 330 determines whether or not the request received from the terminal device 110 is the transmission request (step S14). When determining that the request received from the terminal device 110 is not the transmission request (step S14: NO), the registering unit 350 terminates the execution of the registering process.

When determining that the request received from the terminal device 110 is the transmission request (step S14: YES), the information obtaining unit 330 obtains the bidding user ID, the bidding product ID, and the bid price all contained in the bidding request (step S15).

Next, the registering unit 350 updates the highest bidder ID of the product ID and the current price thereof corresponding to the bidding product ID stored in the bidding table 312 in FIG. 5 with the bidding user ID and the bid price, respectively (step S16). Subsequently, the registering unit 350 terminates the execution of the registering process.

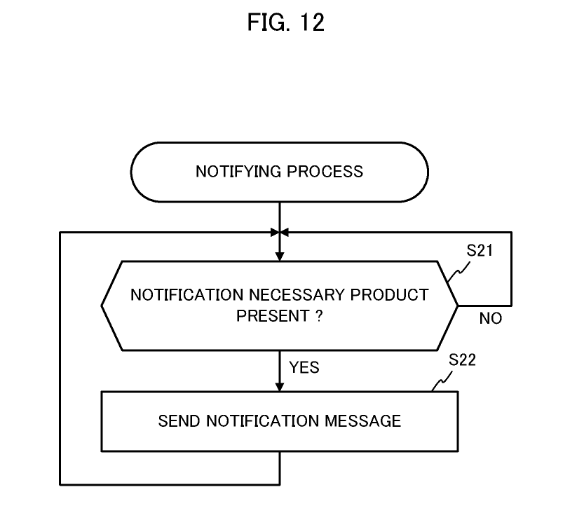

Next, an explanation will be given of a notifying process executed by the notifying device 300. FIG. 12 is an example flowchart of the notifying process. The notifying process illustrated in FIG. 12 starts upon, for example, power activation of the notifying device 300.

First, the notification sending unit 360 obtains the current date and hour from, for example, an OS (Operating System), and determines whether or not, among the products recorded in the bidding table 312 in FIG. 5, there is a product (hereinafter, referred to as a notification necessary product) that has the notification date and hour matching the current date and hour (step S21). When determining that there is no notification necessary product (step S21: NO), the notification sending unit stands by until determining that there is a notification necessary product.

When determining that there is the notification necessary product (step S21: YES), the notification sending unit 360 sends the notification message to the user (step S22).

More specifically, the notification sending unit 360 sends, to the destinations that are the multiple user IDs registered in the watch list associated with the product ID of the notification necessary product, a notification mail that contains a notification message and as illustrated in FIG. 8.

Subsequently, the notification sending unit 360 repeatedly executes the processes in the steps S21 and S22.

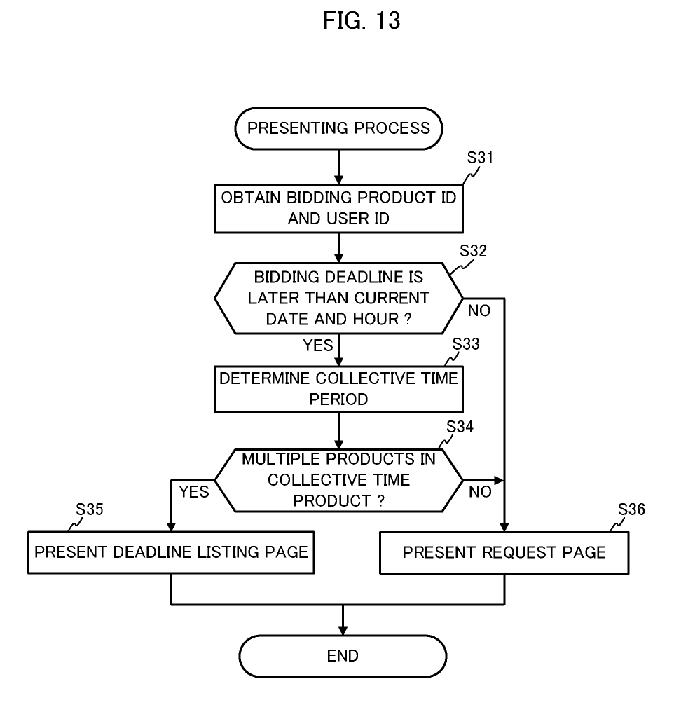

Next, an explanation will be given of a presenting process executed by the notifying device 300. FIG. 13 is an example flowchart of the presenting process. The presenting process illustrated in FIG. 13 starts upon, for example, receiving the transmission request from the terminal device 110.

First, the information obtaining unit 330 obtains the bidding product ID and the user ID both contained in the transmission request received from the terminal device 110 (step S31).

Next, the presenting unit 370 refers to the bidding table 312, and determines whether or not the bidding deadline for the product ID corresponding to the bidding product ID obtained by the information obtaining unit 330 is the later time than the current date and hour (step S32).

When determining that the bidding deadline for the product ID corresponding to the bidding product ID is the later time than the current date and hour (step S32: YES), the presenting unit 370 determines the collective time period for the notification of the bidding deadline for the product that has this bidding product ID (step S33). More specifically, the presenting unit 370 determines, as the collective time period, a time period from a time point advanced from the bidding deadline for the bidding product ID by the first time length to a later time point than the bidding deadline by the second time length.

Next, the presenting unit 370 determines whether or not there are multiple products reaching the respective bidding deadlines within the determined collective time period among the products with the user ID which is contained in the transmission request and which is registered in the watch list of the bidding table 312 (step S34).

When determining that there are multiple products reaching the respective bidding deadlines within the determined collective time period (step S34: YES), the presenting unit 370 presents, to the terminal device 110, the deadline listing page 70 that contains the links to the respective request pages 50 for those multiple products (step S35). Next, the presenting unit 370 terminates the presenting process.

When determining that there are no multiple products reaching the respective bidding deadlines within the determined collective time period, that is, when determining that there is only the product relevant to the biding ID and reaching the bidding deadline within the collective time period (step S34: NO), the presenting unit 370 presents, to the terminal device 110, the request page 50 for the product relevant to this bidding product ID (step S36). Next, the presenting unit 370 terminates the presenting process.

Although determining that the bidding deadline for the product ID corresponding to the bidding product ID is not the later time than the current date and hour (step S32: NO), the presenting unit 370 presents, to the terminal device 110, the request page 50 for the product relevant to this bidding product ID (step S36). In this case, the bidding deadline has been already elapsed, and the auction for the product relevant to this bidding product ID has been already ended. Hence, the user of the terminal device 110 can check the winning bidder and the hammer price based on the information on the product contained in the request page 50.

According to those structures, when the user who has been notified of the request deadline takes an action designated for the notification within the request deadline, and when the transaction reaching the deadline within the collective time period including a transaction relevant to this notification is only the transaction relevant to the notification, the notifying device 300 presents the transaction request page 50 to the terminal device 110. In addition, when the transactions reaching the deadline within the collective time period including a transaction relevant to this notification are other than the transaction relevant to the notification, the notifying device presents the deadline listing page 70 that collects up pieces of information on the respective transaction request pages 50. Hence, when there are multiple transactions with near request deadlines, pieces of information on the respective request pages 50 for those transactions are collectively presented to the user, and thus the notifying device can surely prevent the user from forgetting to make a request in comparison with conventional technologies.

### Second Embodiment

In the first embodiment, the explanation was given of an example case in which the notifying device 300 determines the notification date and hour of sending, to the user, the notification message for each transaction based on the preset notification interval, and determines the collective time period including the transaction deadline subjected to the notification by applying the preset first time length and second time length. However, the first time length, the second time length, and the notification interval may be each a dynamically variable value instead of the preset value. In a second embodiment, an explanation will be given of an example case in which a reaction level to the given notification is calculated based on an action taken for each transaction within the collective time period, and the notifying device 300 updates the first time length, the second time length, and the notification interval so as to improve the calculated reaction level. In the notifying device 300 of the second embodiment, the same structure and function as those of the notifying device 300 of the first embodiment will be denoted by the same reference numeral, and the detailed explanation thereof will be omitted.

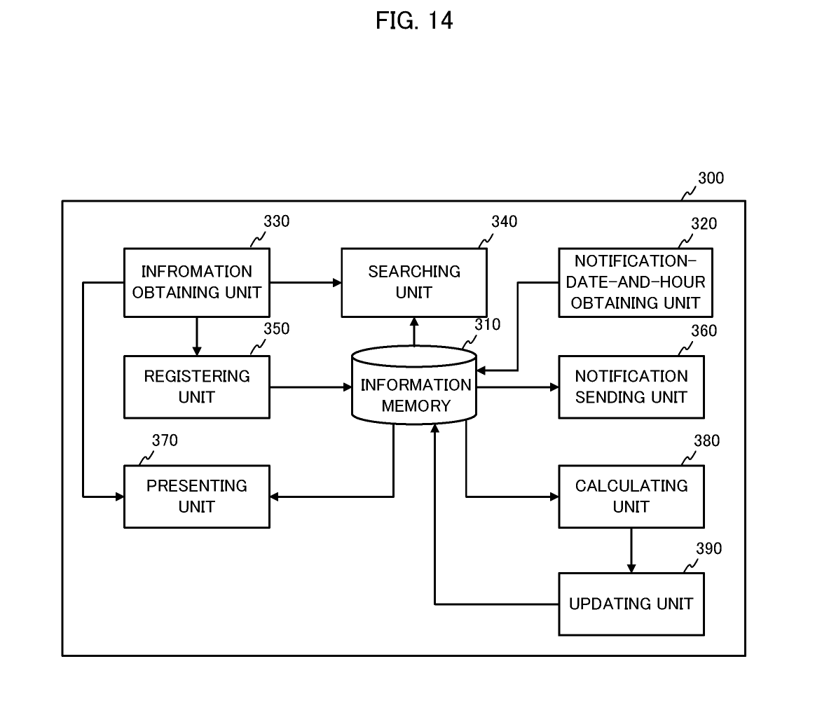

First, functions of the notifying device 300 of the second embodiment will be explained. As illustrated in FIG. 14, the notifying device 300 of the second embodiment further functions as, in addition to the respective elements of the first embodiment illustrated in FIG. 3, a calculating unit 380, and an updating unit 390.

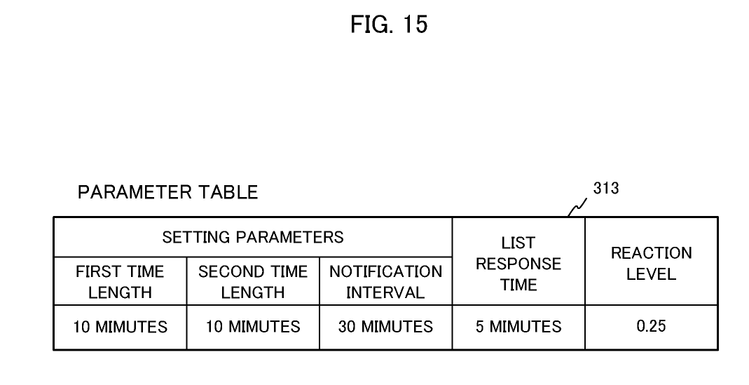

In addition, the information memory 310 of the second embodiment stores a parameter table 313 which stores a first time length, a second time length, and a notification interval (hereinafter, collectively referred to as setting parameters), and which is illustrated in FIG. 15. The parameter table 313 stores a record associated with the setting parameters and information for updating the setting parameters which are a list response time and the reaction level. The setting parameter stored in the parameter table 313 are applied as the first time length, the second time length, and the notification interval all explained in the first embodiment.

The list response time is a time from a time point at which the notification mail is sent to an access time point at which the user takes an action designated in the notification mail, and accesses the request page 50 from the deadline listing page 70 presented by the notification device 300 until the bidding deadline for the product subjected to the notification. When the user accesses the multiple request pages 50 from the deadline listing page 70, the list response time is calculated as an average of times from a time point at which the notification mail is sent to an access time point to each request page 50.

The reaction level is a measure representing how short a time is after the notification is given to the user and until a specific action is made. In the second embodiment, the specific action is to access the request page 50 from the deadline listing page 70 presented by the notifying device 300 until the bidding deadline for the product subjected to the notification. Hence, the shorter the list response time is, the higher the calculated reaction level becomes.

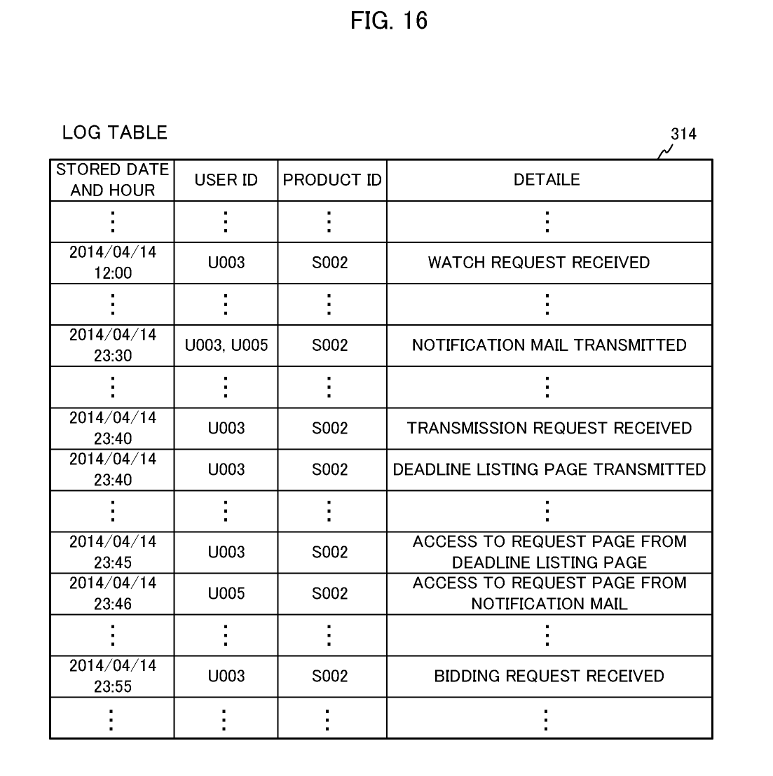

In addition, the information memory 310 stores a log table 314 which stores a log utilized for calculating the list response time and which is illustrated in FIG. 16. The log table 314 stores multiple records associated with the stored date and hour of the log, the detail of the log, and the user ID and the product ID both relevant to the detail of the log.

The calculating unit 380 calculates, based on the action taken by the user to the transaction within the collective time period, the reaction level to the given notification. When, for example, the action is that the user accesses the request page 50 of each transaction within the collective time period from the deadline listing page 70 after the notification is sent, the calculating unit 380 obtains, as the list response time, a time period from a time point at which the notification is given to a time point at which the user accesses the request page 50 of each transaction within the collective time period from the deadline listing page 70. Next, the calculating unit 380 calculates the reaction level that has a negative correlation with the list response time. That is, the shorter the time after the user receives the notification mail and until the user accesses the request page 50 through the deadline listing page 70, the higher the calculated reaction level by the calculating unit 380 becomes. An appropriate calculation formula for calculating the reaction level by the calculating unit 380 can be set and designed freely by a person skilled in the art.

The updating unit 390 updates the first time length, the second time length, and the notification interval all recorded in the parameter table 313 so as to improve the reaction level calculated by the calculating unit 380. For example, the updating unit 390 tentatively changes the values of the first time length, the second time length, and the notification interval all stored in the parameter table 313, and when the reaction level calculated by the calculate 380 improves consequently, the tentatively changed values of the first time length, the second time length, and the notification interval are stored as the updated values thereof in the fields of the parameter table 313.

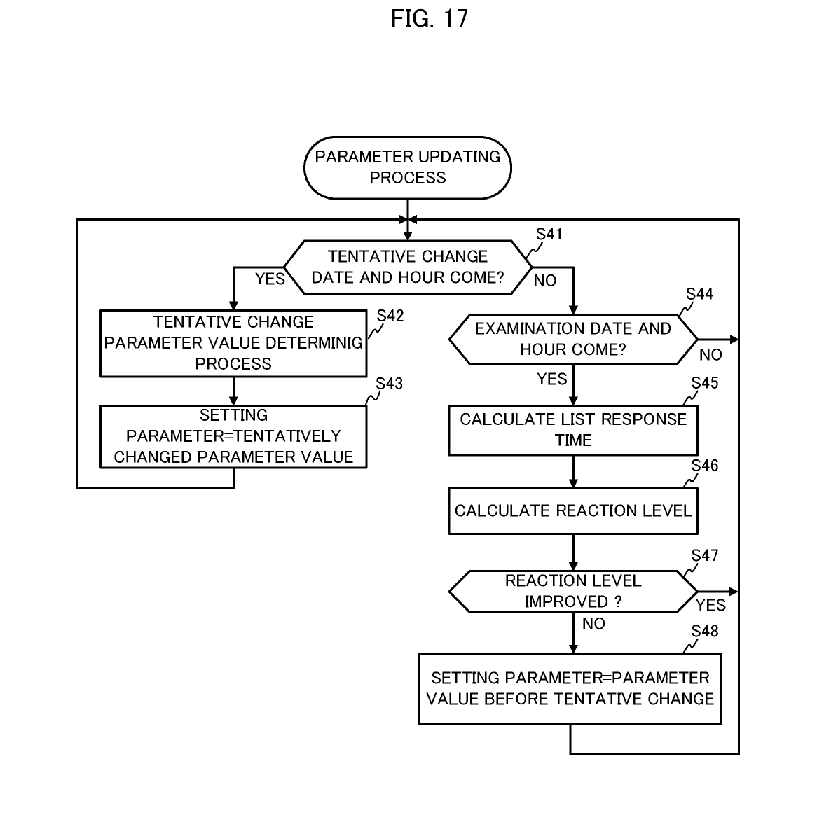

Next, an explanation will be given of a parameter updating process executed by the notifying device 300. FIG. 17 is an example flowchart of the parameter updating process. The parameter updating process illustrated in FIG. 17 starts upon, for example, power activation of the notifying device 300.

First, the updating unit 390 obtains the current date and hour. Next, the updating unit 390 determines (step S41), based on whether or not the current date and hour is the later date and hour than the tentative change date and hour of the setting parameters, whether or not the tentative change date and hour comes.

At this time, when the updating unit 390 determines that the tentative change date and hour comes (step S41: YES), the updating unit 390 executes a tentative change parameter value determining process of determining the tentatively changed value of each setting parameter (step S42). At this time, the updating unit 390 determines, at random, whether or not to increase or decrease the currently set value of the setting parameter recorded in the parameter table 313 by a predetermined value, and determines a tentatively changed parameter value based on this determined value.

Next, the updating unit 390 updates the values of the setting parameters recorded in the parameter table 313 with the tentatively changed parameter values (step S43). In addition, the updating unit 390 stores the values of the setting parameters prior to the tentative change and recorded in the parameter table 313 and the value of the reaction level as parameters prior to tentative change and a reaction level prior to the tentative change, respectively. Next, the updating unit 390 returns the process to the step S41.

When the updating unit 390 determines that the tentative change date and hour has not come yet (step S41: NO), the updating unit 390 determines, based on whether or not the current time is the later time than an examination date and hour, whether or not the examination date and hour comes (step S44). When determining that the examination date and hour has not come yet (step S44: NO), the updating unit 390 returns the process to the step S41.

When determining that the examination date and hour comes (step S44: YES), the calculating unit 380 calculates the list response time (step S45).

In this case, an explanation will be given of an example calculation method of the list response time. The calculating unit 380 refers to the log table 314 in FIG. 16, and specifies a set of the user ID of the user who has the corresponding detail that is “an access to the request page from the deadline listing page” and the product ID, and, the stored date and hour of such a set. Next, the calculating unit 380 specifies, in the specified sets of the respective user IDs and the respective product IDs, the stored date and hour with the detail that corresponds to “deadline listing page sent”. Subsequently, the calculating unit 380 calculates the list response time based on two specified stored dates and hours. When specifying multiple sets of the respective user IDs and the respective product IDs corresponding to “an access to the request page from the deadline listing page”, the calculating unit 380 obtains, as the list response time applied for the calculation of the reaction level, an average value of the list response times calculated from the respective sets. Next, the calculating unit 380 stores the calculated list response time in the parameter table 313.

Subsequently, the calculating unit 380 calculates the reaction level that has a negative correlation with the calculated list response time (step S46). When, for example, the list response time is T [minutes], the calculating unit 380 calculates a reaction level R that is 1/T. Next, the calculating unit 380 stores the calculated reaction level in the parameter table 313.

Subsequently, the updating unit 390 determines, based on whether or not the calculated reaction level in the step S46 is larger than the reaction level prior to the tentative change, whether or not the reaction level has improved (step S47). At this time, when determining that the reaction level has improved (step S47: YES), the updating unit 390 keeps the values of the setting parameters in the parameter table 313 in FIG. 15 as the tentatively changed parameter values, and returns the process to the step S41.

When determining that the reaction level does not improve (step S47: NO), the values of the setting parameters in the parameter table 313 in FIG. 15 are changed from the tentatively changed parameter values to the values of the parameters prior to the tentative change (step S48), and returns the process to the step S41.

According to those structures, the notifying device 300 updates the first time length and the second time length so as to improve the reaction level that is calculated based on an action taken until the deadline by the user who has notified of the deadline. Hence, the collective time period can be set so as to enhance the reaction level of the user, and thus even if there are multiple bidding deadlines within the short time period, the notifying device can surely prevent the user from forgetting to make a request for each bidding.

The notifying device 300 updates the notification interval so as to improve the reaction level calculated based on an action taken until the deadline by the user who has been notified of the deadline. Hence, a notification can be given at an appropriate time period that can enhance the reaction level of the user, and thus the notifying device can surely prevent the user from forgetting to make a request for bidding since the grace period between the notification and the deadline is too long or from missing the deadline for bidding since the grace period is too short.

Still further, the notifying device 300 updates, when the reaction level improves by tentatively changing the first time length, the second time length, and the notification interval, the first time length, the second time length, and the notification interval with the respective tentatively changed values. Hence, more appropriate setting of the collective time period and that of the notification interval are enabled.

Yet still further, the notifying device 300 updates the first time length, the second time length, and the notification interval so as to improve the reaction level that has a negative correlation with the list response time. Hence, the list response time can be reduced in comparison with conventional technologies, and thus the notifying device can surely prevent the user from forgetting to access the request page 50 after receiving the notification.

### Third Embodiment

In the second embodiment, an explanation was given of an example case in which the first time length, the second time length, and the notification interval are updated in accordance with the list response time. In a third embodiment, as another example, an explanation will be given of a case in which the notifying device 300 updates the first time length, the second time length, and the notification interval in accordance with the number of accesses to the request pages 50 from the deadline listing page 70. In the notifying device 300 of the third embodiment, the same structure and function as those of the notifying device 300 of the second embodiment will be denoted by the same reference numeral, and the detailed explanation thereof will be omitted.

In the third embodiment, the calculating unit 380 calculates, instead of the step S45 in the parameter updating process of the second embodiment in FIG. 17, the number of accesses by the user to the request pages 50 from the deadline listing page 70 after the notification has been given. For example, the calculating unit 380 refers to the log table 314 in FIG. 16, and specifies, within the time period to which the current setting parameters are applied, the number of sets (the number of accesses) of the respective user IDs of the users who have the corresponding detail that is “an access to the request page from the deadline listing page”, and the respective product IDs. In addition, the calculating unit 380 refers to the bidding table 312 in FIG. 5, and specifies the total number of products reaching the respective bidding deadlines within the time period to which the current setting parameters are applied. Next, the calculating unit 380 calculates the rate of the number of accesses relative to the specified total number of products.

Subsequently, the calculating unit 380 calculates, instead of the step S46 in the parameter updating process of the second embodiment in FIG. 17, the reaction level so as to have a positive correlation with the calculated rate of the number of accesses. That is, the larger the number of accesses to the request pages 50 by the users from the deadline listing page 70 is, the higher the calculated reaction level by the calculating unit 380 becomes. The appropriate calculation formula applied for the calculating unit 380 to calculate the reaction level can be set and designed freely by a person skilled in the art.

According to this structure, the notifying device 300 updates the first time length, the second time length, and the notification interval so as to improve the reaction level that has a positive correlation with the number of accesses to the request pages 50 from the deadline listing page 70. Hence, even if there are multiple bidding deadlines within a short time period, it becomes possible for the notifying device not to forget the user to make a request for each bidding, and to increase the number of accesses to the request pages 50, thereby prompting further active transactions.

### Fourth Embodiment

In the fourth embodiment, an explanation will be given of an example case in which the notifying device 300 updates the first time length, the second time length, and the notification interval in accordance with the number of bidding requests from the request pages 50 accessed from the deadline listing page 70. In the notifying device 300 of the fourth embodiment, the same structure and function as those of the notifying device 300 of the second embodiment will be denoted by the same reference numeral, and the detailed explanation thereof will be omitted.

In the fourth embodiment, the calculating unit 380 calculates, instead of the step S45 in the parameter updating process of the second embodiment in FIG. 17, the number of bidding requests from the request pages 50 accessed by the user from the deadline listing page 70 after the notification has been given. For example, the calculating unit 380 refers to the log table 314 in FIG. 16, and specifies, within the time period to which the current setting parameters are applied, the sets of the respective user IDs of the users who have the corresponding detail that is “an access to the request page from the deadline listing page”, and the respective product IDs. In addition, the calculating unit 380 specifies the number of sets (the number of bidding requests) of the respective user IDs who have the recorded corresponding detail that is “bidding request received”, and the respective product IDs. Still further, the calculating unit 380 refers to the bidding table 312 in FIG. 5, and specifies the total number of products reaching the bidding deadline within the time period to which the current setting parameters are applied. Next, the calculating unit 380 calculates the rate of the number of bidding requests relative to the specified total number of products.

Subsequently, the calculating unit 380 calculates, instead of the step S46 in the parameter updating process of the second embodiment in FIG. 17, the reaction level so as to have a positive correlation to the calculated rate of the number of bidding requests. That is, the larger the number of bidding requests from the request pages 50 accessed by the users from the deadline listing page 70 is, the higher the calculated reaction level by the calculating unit 380 becomes. The appropriate calculation formula applied for the calculating unit 380 to calculate the reaction level can be set and designed freely by a person skilled in the art.

According to this structure, the notifying device 300 updates the first time length, the second time length, and the notification interval so as to improve the reaction level that has a positive correlation with the number of accesses to the request pages 50 from the deadline listing page 70. Hence, even if there are multiple bidding deadlines within a short time period, it becomes possible for the notifying device not to forget the user to make a request for each bidding, and to increase the number of bidding requests, thereby prompting further active transactions.

### Fifth Embodiment

In the first embodiment, the explanation was given of an example case in which the notifying device 300 sends the notification mail to the terminal device 110, but the notification of the bidding deadline may be given through a mail server to the terminal device 110. In a fifth embodiment, an explanation will be given of an example case in which the notifying device 300 gives a notification to the terminal device 110 through the mail server. In the notifying device 300 of the fifth embodiment, the same structure and function as those of the notifying device 300 of the first embodiment will be denoted by the same reference numeral, and the detailed explanation thereof will be omitted.

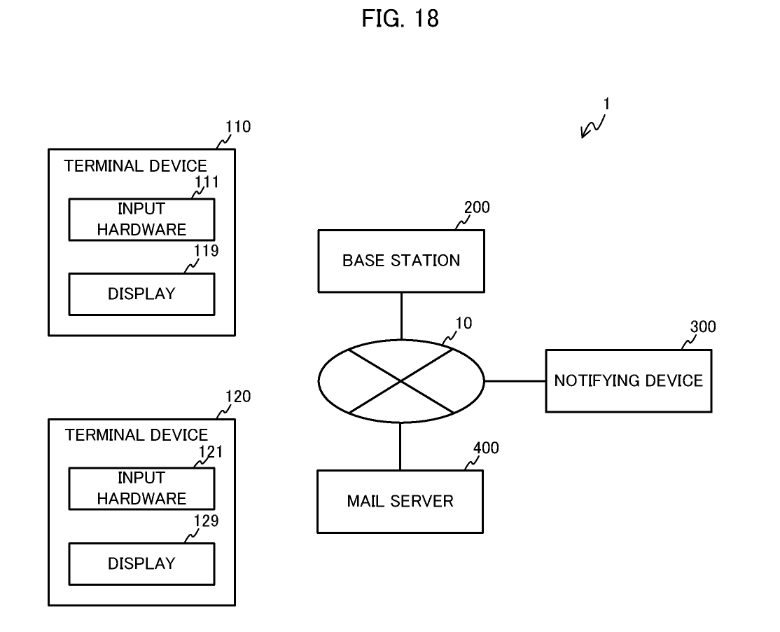

The notifying system 1 of the fifth embodiment includes, as illustrated in FIG. 18, the terminal devices 110 and 120, the base station 200 wirelessly communicable with the terminal devices 110, 120, and the notifying device 300 and a mail server 400 both communicably connected with the base station 200 via the computer communication network 10 (hereinafter, simply referred to as the communication network 10).

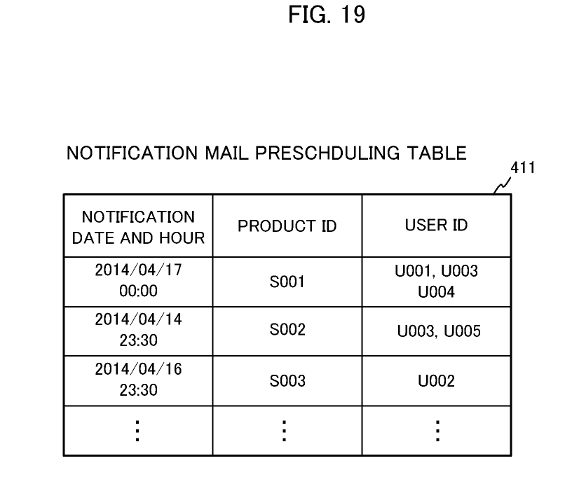

The mail server 400 is, for example, a server device that includes the same hardware resources as those of the notifying device 300 of the first embodiment illustrated in FIG. 2. In addition, as illustrated in FIG. 19, the mail server 400 stores a notification mail prescheduling table 411 received from the notifying device 300. The notification mail prescheduling table 411 stores, for each product subjected to a notification mail to be sent, the product ID, the notification date and hour, and the user ID that is a destination in association one another. When the current date and hour becomes consistent with the notification date and hour stored in the notification mail prescheduling table 411, the mail server 400 transmits, to the destination that is the user ID corresponding to the notification date and hour, the notification mail indicating that the bidding deadline for the product ID corresponding to the notification date and hour is soon.

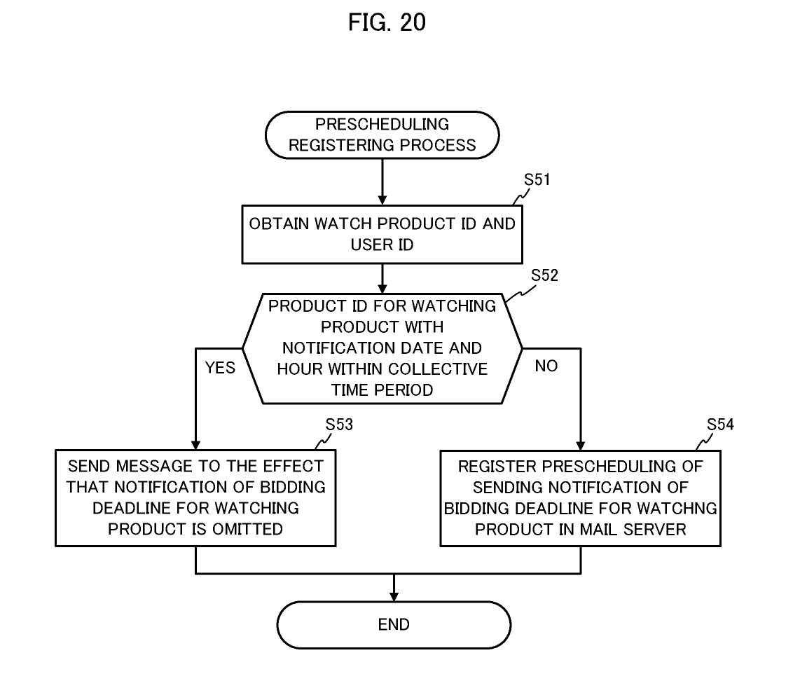

In addition, the notification sending unit 360 of the notifying device 300 of the fifth embodiment executes, instead of the notifying process illustrated in FIG. 12, a prescheduling registering process illustrated in FIG. 20 as an example. The prescheduling registering process illustrated in FIG. 20 starts upon, for example, receiving the watch request from the terminal device 110.

First, the information obtaining unit 330 obtains the user ID and the watching product ID both contained in the watch request (step S51).

Next, the notification sending unit 360 refers to the bidding table 312 in FIG. 5, and determines (step S52) whether or not there is a product ID which corresponds to the user ID contained in the watch request, has the corresponding bidding deadline preceding from the bidding deadline corresponding to the watching product ID, and has the notification date and hour corresponding to the watching product ID within the collective time period set for this product ID.

When determining that there is the product ID containing the notification date and hour corresponding to the watching product ID within the collective time period (step S52: YES), the notification sending unit 360 sends (step S53), to the user with the user ID contained in the watch request, a message to the effect that the notification of the deadline for the product with the watching product ID will be omitted. Next, the notification sending unit 360 terminates the prescheduling registering process.

In addition, when determining that there is no product ID containing the notification date and hour corresponding to the watching product ID within the collective time period (step S52: NO), the notification sending unit 360 registers, in the notification mail prescheduling table 411 of the mail server 400, the watching product ID, the notification date and hour, and the user ID contained in the watch request, thereby registering prescheduling of sending a mail that describes the notification of the bidding deadline for the product with the watching product ID to the user who has this user ID (step S54). Next, the notification sending unit 360 terminates the prescheduling registering process.

According to those structures, when a newly watching product is added, the notifying device 300 can reduce the number of notification mails to be sent without canceling the prescheduled notification already registered in the mail server 400.

The first to fifth embodiments of the present disclosure were explained above, but the present disclosure is not limited to first to fifth embodiments.

For example, the presenting unit 370 may present, through different browser windows from each other or different tabs from each other in the browser, all request pages 50 of the products reaching the respective bidding deadlines within the collective time period instead of presenting the deadline listing page 70.

In the above first to fifth embodiments, the deadline list 71 contains the products reaching the respective bidding deadlines within the collective time period, but the products contained in the deadline list 71 are not limited to this type, and for example, a product reaching the bidding deadline within the collective time period may be contained. For example, the deadline list 71 may contain all products in the watch list which have the user ID registered in the bidding table 312 and contained in the transmission request.

In addition, the explanation was given of the electronic transactions in the above first to fifth embodiments, but the present disclosure is not limited to this case, and transactions may be, instead of business transactions, free loaning and leasing. In addition, the transactions may be transactions other than electronic transactions, and a part of or all of the transaction may be not performed through electronic information communication via a computer network.

Still further, in the above first to fifth embodiments, as example transactions with a set request deadline, auction transactions were explained, but the present disclosure is not limited to this type of transaction, and the transaction may be a transaction set with a time-sale and a special-sale time period.

In the above first to fifth embodiments, as an example transaction request, a placement of bidding to an auction was explained, but the present disclosure is not limited to this type of request, and for example, the request may be a purchase request for a product, and a request for rent.

In the above first to fifth embodiments, things for the transaction were the products, but may be services, and may be everything subjected to transaction. The term product means an object that can be subjected to a business transaction, and is not limited to a movable property, but includes an immovable property, but the present disclosure is not limited to those matters. The term service means a work or a benefit for somebody else which can be subjected to a business transaction independently, but the present disclosure is not limited to those matters.

In addition, the first to fifth embodiments can be combined together. The present disclosure can be provided as, needless to say, the notifying device 300 that employs the structure which realizes the functions of any one of the first to fifth embodiments, a system that includes multiple devices, and also includes, as a whole system, the structure that can realize the functions of any one of the first to fifth embodiments.

In the above first to fifth embodiments, the program executed by the notifying device 300 may be distributed in a manner stored in a non-transitory computer-readable recording medium, such as a flexible disc, a Compact Disk Read-Only Memory (CD-ROM), a Digital Versatile Disk (DVD), or an Magneto-Optical Disk (MO). Next, such a program may be installed in an information processing device like a personal computer to realize the notifying device 300 that executes the above processes.

Still further, the program may be stored in a disk device of a predetermined server device over the communication network like the Internet. Next, the program may be downloaded in a manner superimposed on, for example, carrier waves.

When the above functions are shared by an Operating System (OS) or are realized by the cooperative operations of the OS with an application, portions other than portions realizing the functions of the OS may be distributed in a manner stored in a non-transitory recording medium, or may be downloaded.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for electronic transactions that utilize a computer communication network like the Internet.

### REFERENCE SIGNS LIST

1 Notifying system

10 Computer communication network

110, 120 Terminal device

111, 121 Input hardware

119, 129 Display

200 Base station

300 Notifying device

3001 CPU

3002 ROM

3003 RAM

3004 Hard disk

3005 Media controller

3006 LAN card

3007 Video card

3008 LCD

3009 Keyboard

3010 Speaker

3011 Touch pad

310 Information memory

311 Product table

312 Bidding table

313 Parameter table

314 Log table

320 Notification-date-and-hour obtaining unit

330 Information obtaining unit

340 Searching unit

350 Registering unit

360 Notification sending unit

370 Presenting unit

380 Calculating unit

390 Updating unit

400 Mail server

411 Notification mail prescheduling table 411

40 Search page

41 Search result page

50 Request page

51 Product information

52 Register button

53 Bid button

60 Notification message

61 page jump button

70 Deadline listing page

71 Deadline list

1. A notifying device comprising:
an obtaining unit that obtains a notification date and hour which is associated with each of a plurality of transactions watched by a user, and which precedes by a set time interval from a deadline for the each transaction;
a notification sending unit that sends a notification of the deadline for the each transaction to the user after the notification date and hour associated with the each transaction comes; and
a presenting unit which determines, when the notified user takes an action designated in the notification by the deadline for the transaction subjected to the notification, a collective time period that contains the deadline for the transaction subjected to the notification among the plurality of transactions, presents to the user a request page of the transaction subjected to the notification when the transaction reaching the deadline within the collective time period is only the transaction subjected to the notification, and collects up and presents to the user pieces of information of respective request pages for the transactions reaching the deadline within the collective time period when there are plurality of the transactions reaching the deadline within the collective time period, wherein
a start of the collective time period is a time point preceding the deadline of the transaction by a first time length;
an end of the collective time period is a time point later than the deadline of the transaction by a second time length; and
the notifying device further comprises:
a calculating unit that calculates a reaction level to the sent notification based on an action taken by the user to the each transaction reaching the deadline within the collective time period; and
an updating unit that updates the first time length, the second time length and the time interval so as to improve the calculated reaction level.

2. The notifying device according to claim 1, wherein the presenting unit presents to the user a listing page that lists up links to the respective request pages for the transactions reaching the deadline within the collective time period, thereby collectively presenting to the user the pieces of information for the respective request pages for the transactions within the collective time period.

3. (canceled)

4. The notifying device according to claim 1, wherein when the reaction level improves by tentatively changing the first time length, the second time length, and the time interval, the updating unit updates the first time length, the second time length, and the time interval with the respective tentatively changed values.

5. The notifying device according to claim 4, wherein:
the action is to access the request page for the each transaction within the collective time period by the user from the listing page after the notification is sent; and
the reaction level is calculated so as to have a negative correlation with an average of times from a time point at which the notification is sent to a time point at which the access to the request page for the each transaction within the collective time period is made.

6. The notifying device according to claim 4, wherein:
the action is to access the request page for the each transaction within the collective time period by the user from the listing page after the notification is sent or to make a request from the request page accessed from the listing page; and
the reaction level is calculated so as to have a positive correlation with a number of accesses or a number of requests.

7. The notifying device according to claim 1, wherein the presenting unit presents, through different browser windows from each other or different tabs from each other in a browser, all request pages of the respective transactions within the collective time period, thereby collectively presenting to the user the pieces of information for the respective request pages for the transactions reaching the deadline within the collective time period.

8. The notifying device according to claim 1, wherein the notifying device:
determines, every time the user sets a new transaction as a watching target, whether or not a condition is satisfied, the condition being that “there is an existing transaction watched by the user, the deadline of the existing transaction is faster than the deadline of the new transaction, and the notification date and hour of the new transaction is contained within the collective time period set for the existing transaction”;
registers, in the mail server, prescheduling of transmitting a mail described with the notification of the deadline for the new transaction at the notification date and hour of the new transaction when the condition is unsatisfied; and
notifies the user of an omission of the notification of the deadline for the new transaction when the condition is satisfied.

9. A notifying method executed by a notifying device that includes an obtaining unit, a notification sending unit, and a presenting unit, the method comprising:
obtaining a notification date and hour which is associated with each of a plurality of transactions watched by a user, and which precedes by a set time interval from a deadline for the each transaction;
sending notification of the deadline for the each transaction to the user after the notification date and hour associated with the each transaction comes; and
determining, when the notified user takes an action designated in the notification by the deadline for the transaction subjected to the notification, a collective time period that contains the deadline for the transaction subjected to the notification among the plurality of transactions, presenting to the user a request page of the transaction subjected to the notification when the transaction reaching the deadline within the collective time period is only the transaction subjected to the notification, and collecting up and presenting to the user pieces of information of respective request pages for the transactions reaching the deadline within the collective time period when there are plurality of the transactions reaching the deadline within the collective time period, wherein
a start of the collective time period is a time point preceding the deadline of the transaction by a first time length;
an end of the collective time period is a time point later than the deadline of the transaction by a second time length; and
the method further comprises:
calculating a reaction level to the sent notification based on an action taken by the user to the each transaction reaching the deadline within the collective time period; and
updating the first time length, the second time length and the time interval so as to improve the calculated reaction level.

10. (canceled)

11. (canceled)

12. A notifying device comprising:
an obtaining unit that obtains a notification date and hour which is associated with each of a plurality of transactions watched by a user, and which precedes by a set time interval from a deadline for the each transaction;
a notification sending unit that sends a notification of the deadline for the each transaction to the user after the notification date and hour associated with the each transaction comes; and
a presenting unit which determines, when the notified user takes a an action designated in the notification by the deadline for the transaction subjected to the notification, a collective time period that contains the deadline for the transaction subjected to the notification among the plurality of transactions, and to present to the user:
(a) according to the action, a request page of the transaction subjected to the notification if the transaction reaching the deadline within the collective time period is only the transaction subjected to the notification, and
(b) according to the action, a list page listing links to each request page of the transactions reaching the deadline within the collective time period if there are plurality of the transactions reaching the deadline within the collective time period.
